(19) United States
(12) Patent Application Publication
(10) Pub. No.: US 2019/0308629 A1
(43) Pub. Date: Oct. 10, 2019

(54) SYSTEMS AND METHODS FOR ROUGH ROAD DETECTION

(71) Applicant: GM GLOBAL TECHNOLOGY OPERATIONS LLC, DETROIT, MI (US)

(72) Inventor: Steven Aiuto, Commerce Twp., MI (US)

(21) Appl. No.: 15/946,751

(22) Filed: Apr. 6, 2018

(51) Int. Cl. B60W 40/06; G01B 21/30

(52) U.S. Cl. CPC B60W 40/06; G01B 21/30; B60W 2510/227; B60W 2710/22; B60W 2750/00; B60W 2710/202; B60W 2510/202

(57) ABSTRACT

An exemplary method for detecting a rough road includes the steps of providing a vehicle sensor, the vehicle sensor configured to measure a steering torque of a vehicle, receiving a steering torque data signal from the vehicle sensor, generating a road condition data signal from the steering torque data signal, evaluating the road condition data signal over a specified time interval, comparing the road condition data signal with one or more thresholds, and determining whether rough road conditions exist based on the comparison of the road condition data signal with the one or more thresholds over the specified time interval.

### INTRODUCTION

The present invention relates generally to the field of vehicles and, more specifically, to systems and methods for rough or uneven road detection by monitoring steering torque oscillations.

When a vehicle travels over rough road, vibration is transmitted through wheels of the vehicle, possibly producing adverse effects. Variations in wheel speed caused by the rough road can also stress other engine and drivetrain components. Outputs generated by engine speed (revolutions per minute) and throttle pedal position sensors may also be impacted by the vibration from the rough road. For example, bouncing of the vehicle caused by rough road may cause the driver's foot to bounce on the accelerator pedal in a constructive interference pattern.

### SUMMARY

Embodiments according to the present disclosure provide a number of advantages. For example, embodiments according to the present disclosure enable detection of vehicle travel over a rough or uneven road surface using steering torque data.

In one aspect, a method for detecting a rough road includes providing a vehicle sensor, the vehicle sensor configured to measure a steering torque of a vehicle, receiving a steering torque data signal from the vehicle sensor, generating a road condition data signal from the steering torque data signal, evaluating the road condition data signal over a specified time interval, comparing the road condition data signal with one or more thresholds, and determining whether rough road conditions exist based on the comparison of the road condition data signal with the one or more thresholds over the specified time interval.

In some aspects, comparing the road condition data signal with one or more thresholds includes comparing the road condition data signal with a first threshold and a second threshold.

In some aspects, the first threshold is a positive upper threshold and the second threshold is a negative lower threshold.

In some aspects, the method further includes generating a rough road detection signal if the road condition data signal exceeds both of the first and second thresholds within the specified time interval.

In some aspects, evaluating the road condition data signal further includes determining a frequency of oscillations in the road condition data signal within the specified time interval.

In some aspects, determining whether a rough road condition exists further includes evaluating the frequency of oscillations in the road condition data signal within the specified time interval and comparing the frequency of oscillations with a threshold value.

In some aspects, the method further includes calculating a rate of change of the steering torque data signal and comparing the rate of change of the steering torque data signal with a limit value.

In some aspects, the method further includes comparing the rate of change of the steering torque data signal within the specified time interval, and, if the rate of change exceeds the limit value within the specified time interval, generating a rough road detection signal.

In another aspect an automotive vehicle includes a suspension system configured to move in response to travel of the automotive vehicle over a road surface, a steering system coupled to the suspension system, a vehicle sensor configured to measure a steering torque, and a controller in communication with the vehicle sensor, the controller including a road detection system configured to receive sensor data corresponding to the steering torque, generate a road condition data signal, compare the road condition data signal with one or more thresholds, and generate a rough road detection signal based on the comparison of the road condition data signal to the one or more thresholds.

In some aspects, comparing the road condition data signal with one or more thresholds includes comparing the road condition data signal with a first threshold and a second threshold.

In some aspects, the first threshold is a positive upper threshold and the second threshold is a negative lower threshold.

In some aspects, the controller is further configured to generate a rough road detection signal if the road condition data signal exceeds both of the first and second thresholds within a specified time interval.

In some aspects, the controller is further configured to calculate a rate of change of the steering torque data signal and compare the rate of change of the steering torque data signal with a limit value.

In some aspects, the controller is further configured to compare the rate of change of the steering torque data signal within a specified time interval, and, if the rate of change exceeds the limit value with the specified time interval, generate a rough road detection signal.

In yet another aspect, a system for detecting a road condition includes a vehicle sensor configured to measure a vehicle characteristic and a controller in communication with the vehicle sensor, the controller including a data synthesis module that synthesizes data from the vehicle sensor and generates a road condition signal indicative of the road condition, a comparison module that generates a data comparison signal based on a comparison of the road condition signal to one or more thresholds, and a detection module that analyzes the data comparison signal to determine whether a rough road condition is detected.

In some aspects, the data synthesis module calculates a rate of change of the sensor data and the comparison module compares the rate of change to a limit value within a specified time interval.

In some aspects, the comparison module compares the road condition signal to a first threshold and a second threshold, and the first threshold is a positive threshold and the second threshold is a negative threshold.

In some aspects, the detection module generates a rough road detection signal if the road condition signal exceeds both of the first and second threshold within a specified time interval.

### BRIEF DESCRIPTION OF THE DRAWINGS

The present disclosure will be described in conjunction with the following figures, wherein like numerals denote like elements.

FIG. 1 is a schematic diagram of a vehicle having a road condition detection system, according to an embodiment.

FIG. 2 is a flowchart of a method for detecting a road condition, according to an embodiment.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Various vehicle systems, such as chassis control systems, use road condition information to know when and how to adjust various control algorithms including slip detection and other control parameters to optimize vehicle performance. As a vehicle drives over a rough road, the suspension moves in response to the road surface. Each vertical movement of the suspension results in a change in road wheel angle. These changes in road wheel angle travel through the steering system and can result in a torque at the steering wheel. A road condition detection system such as the systems discussed herein provide robust detection of a road condition.

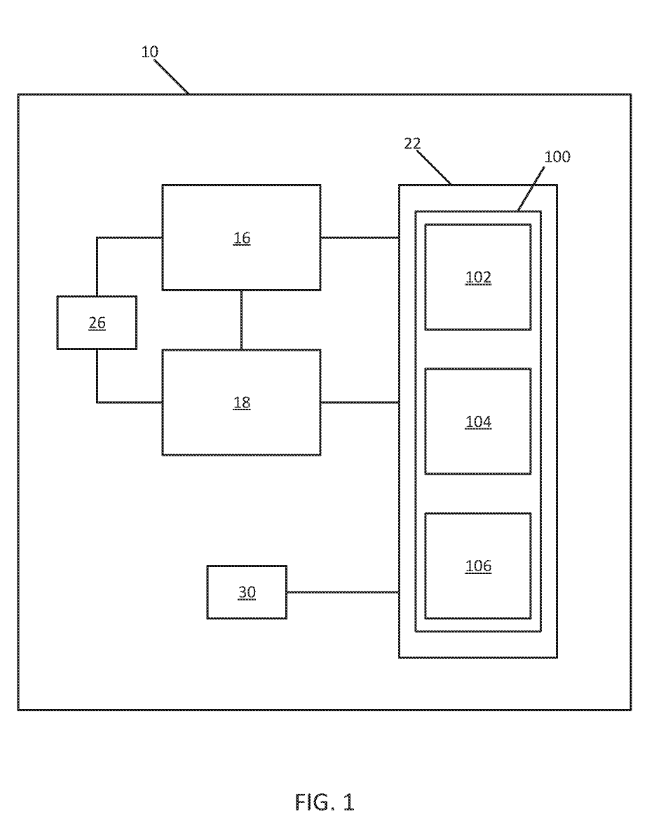

FIG. 1 schematically illustrates an automotive vehicle 10 according to the present disclosure. The vehicle 10 generally includes a steering system 16, which, in some embodiments, includes a steering wheel (not shown). In some embodiments, the steering system 16 is an electronic power steering (EPS) system. The vehicle 10 also generally includes a suspension system 18. The suspension system 18 includes various suspension components configured to move in response to vehicle travel over a rough road. In some embodiments, the suspension components include an upper and lower control arm and a steering tie rod (not shown). The suspension components are coupled to one or more vehicle wheels (not shown) such that as the wheels travel over a rough road surface, the suspension components move in response to the road surface.

With further reference to FIG. 1, the vehicle 10 also includes a plurality of sensors 26 configured to measure and capture data on one or more vehicle characteristics, including but not limited to vehicle speed, vehicle heading, steering wheel angle, steering wheel torque, and movement or travel of one or more suspension components. In the illustrated embodiment, the sensors 26 include, but are not limited to, an accelerometer, a speed sensor, a heading sensor, gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, light level detection sensors, and/or additional sensors as appropriate. In some embodiments, the vehicle 10 also includes a plurality of actuators 30 configured to receive control commands to control steering, shifting, throttle, braking or other aspects of the vehicle 10.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle. In some embodiments, the controller 22 is a steering controller and is part of the steering system 16.

In various embodiments, the controller 22 includes road condition detection system 100. The road condition detection system 100 includes a plurality of modules to detect a road condition, as shown in FIG. 1. That is, suitable software and/or hardware components of the controller 22 (e.g., a processor and a computer-readable storage device) are utilized to process sensor data and determine if the vehicle is traveling over a rough road. The road condition determination is used by other vehicle systems to adjust various vehicle parameters to improve vehicle performance, for example and without limitation.

With continued reference to FIG. 1, the road condition detection system 100 includes a data synthesis module 102, a comparison module 104, and a detection module 106. The data synthesis module 102 synthesizes and processes sensor data received from one or more of the sensors 26, the steering system 16, and the suspension system 18. In various embodiments, the data synthesis module 102 can incorporate information from multiple sensors including but not limited to cameras, accelerometers, torque sensors, steering wheel angle sensors, and/or any number of other types of sensors. In some embodiments, the data synthesis module 102 generates a signal indicative of the road condition based on steering torque data received from one or more vehicle sensors.

The comparison module 104 compares the steering torque data to torque limits predefined to optimize vehicle performance. These limits can be determined from a look-up table, an equation or set of equations, or a combined approach. The limits may include a positive upper bound and a negative lower bound if the steering torque signal is positive or negative depending on the direction of the steering torque. The determination made by the comparison module 104 is used to confirm the rough road detection corresponds to a sustained stretch of a rough road condition rather than a single rough event, such as a bump or pothole. Sustained rough road conditions are, in some embodiments, addressed differently by various vehicle systems than single rough road events. If oscillations in steering torque are detected within the specified time interval, the steering torque data is further evaluated by the detection module 106. The detection module 106 processes sensor data along with other data and analyzes the road condition signal generated by the data synthesis module 102 and the compared data generated by the comparison module 104 to determine whether a rough road condition is detected. In some embodiments, the detection module 106 determines whether the vehicle 10 is traveling over a rough road by evaluating the steering torque data signal over a specified time interval.

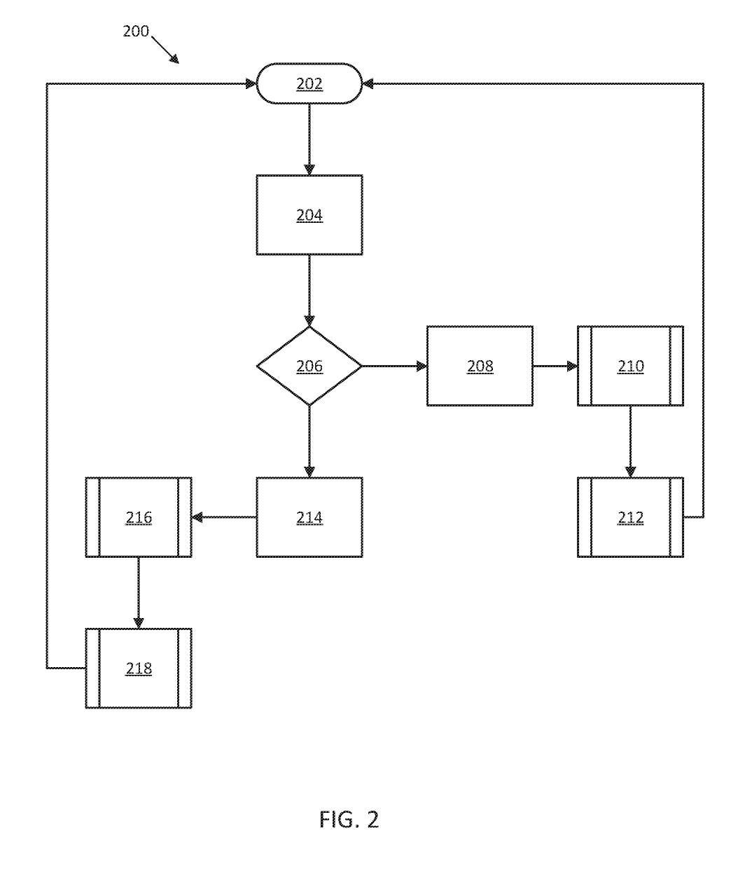

FIG. 2 illustrates a method 200 for detecting a rough road. The method 200 can be utilized in connection with the vehicle 10, including the steering system 16, the suspension system 18, the sensors 26, and the modules of the road condition detection system 100 of the controller 22. The method 200 can be utilized in connection with the controller 22 as discussed herein, or by other systems associated with or separate from the vehicle, in accordance with exemplary embodiments. The order of operation of the method 200 is not limited to the sequential execution as illustrated in FIG. 2, but may be performed in one or more varying orders, or steps may be performed simultaneously, as applicable in accordance with the present disclosure.

Starting at 202, the method 200 starts a timer and proceeds to 204. At 204, the data synthesis module 102 receives sensor data from one or more of the sensors 26. In some embodiments, the sensor data includes steering torque or torsion bar torque data received from the steering system 16. In some embodiments, the steering torque data is torsion bar torque data. In some embodiments, the controller 22 generates a road condition data signal. In some embodiments, the road condition data signal is a calculated rate of change or derivative of the torsion bar torque data. The rate of change of the steering torque data received from the sensors is indicative of the road condition.

Next, at 206, the controller 22 determines whether a rough road condition has been previously detected through other iterations of the method 200.

If the determination made at 206 is negative, that is, a rough road condition has not already been not detected, the method 200 proceeds to 208. At 208, the road condition data signal is compared to both upper and lower thresholds or limits. In some embodiments, the comparison done at 208 is performed by the comparison module 104 of the controller 22. The upper and lower thresholds represent limits that, if exceeded by the torque data received from the sensors 26, indicate that a rough road is detected. In some embodiments, the limits are evaluated separately, that is, the torque data is compared to a first threshold or limit and the torque data is separately compared to a second threshold or limit. In some embodiments, the first threshold is a positive upper threshold and the second threshold is a negative lower threshold, or vice versa.

Next, the torque data comparison generated by the comparison module is evaluated by the detection module 106. At 210, the detection module 106 analyzes the torque data represented by the road condition data signal to determine if both of the positive or upper threshold and the negative or lower threshold are exceeded within an elapsed time. In some embodiments, the elapsed time is approximately 85 ms. In some embodiments, the elapsed time is greater than or less than 85 ms. In some embodiments, the elapsed time depends on the vehicle type and suspension configuration, among other factors. If both of the positive and negative thresholds are exceeded within the elapsed time, the controller 22 determines that a rough road condition is detected. In some embodiments, the rough road condition determination may be sent to other vehicle controllers. In some embodiments, one or more diagnostic flags may be set and the timer may be reset or incremented.

However, at 212, a separate subprocess analyzes the torque data if only one of the positive and negative thresholds has been exceeded with the elapsed time. If only one of the thresholds has been exceeded within the elapsed time, the controller 22 determines that a rough road condition is not detected. In some embodiments, the controller 22 resets the timer and all flags and the method 200 returns to 202 and continues as discussed herein. In some embodiments, if the timer is below the elapsed threshold but only one of the thresholds has been exceeded, the controller 22 increments the time until either the elapsed time has passed or the other of the thresholds has been exceeded. A rough road condition is flagged by the controller 22 when both the upper and lower thresholds are exceeded within the elapsed time. If both of the upper and lower thresholds are not exceeded within the elapsed time, the torque data may indicate a single rough road event, such as a bump or pothole, rather than a sustained rough road condition.

In some embodiments, if the torque data is initially compared to the positive or upper threshold and the torque data exceeds the positive limit, the controller 22 then determines if the torque data has previously exceeded the negative or lower limit. If this determination is also positive, the controller 22 determines that a rough road condition is detected. Similarly, if the torque data is initially compared to the negative or lower threshold and the torque data exceeds the negative limit, the controller 22 then determines if the torque data has previously exceeded the positive or upper limit. If this determination is also positive, the controller 22 determines that a rough road condition is detected.

In some embodiments, determining whether a rough road condition exists includes evaluating a frequency of oscillations in the road condition data signal over a specified time interval and comparing the frequency of oscillations with a threshold value. If the frequency of oscillations within the specified time interval exceeds the threshold value, the controller 22 determines that a rough road condition exists.

However, if the determination made at 206 is positive, that is, that a rough road condition has previously been detected, the method 200 proceeds to 214. At 214, the controller 22 confirms that a rough road condition continues by evaluating the torque data against the positive or upper limit or threshold and the negative or lower limit or threshold to determine if one or both of the limits are exceeded within a specified time interval. In an example of an instantaneous comparison which is performed, in some embodiments, by the comparison module 104, the road condition is rough if the steering torque is positive and larger than the upper limit, or the steering torque is negative and the absolute value of the steering torque is greater than the absolute value of the lower limit.

If one or both of the thresholds are exceeded within the specified time interval, the method 200 proceeds to 216. At 216, the controller 22 increments or resets a timer between occurrences of peaks of the steering torque derivative data. In some embodiments, the controller 22 increases a counter that tracks the number of times a rough road condition is detected and/or sets a flag indicating that a rough road is detected.

If neither threshold is exceeded within the specified time interval, the method 200 proceeds to 218. The controller 22 resets the timer and clears all flags indicating a rough road condition. The method 200 returns to 202 and proceeds as discussed herein.

In some embodiments, the specified time interval is approximately 85ms. In other embodiments, the specified time interval is more or less than 85ms and is tunable based on vehicle characteristics such as vehicle type, etc. The values of the upper and lower thresholds are also tunable and calibratable based on vehicle characteristics such as vehicle type or suspension system, or other characteristics.

The method 200 is one exemplary method for detecting a rough road condition using steering torque data. Additional comparisons or steps may be added to or removed from the method 200 or steps may be performed simultaneously or in an order different than the one presented in FIG. 2. As discussed herein, the derivative or rate of change of the steering torque data is calculated and compared to threshold values to determine a rough road condition. In other embodiments, the steering torque data is compared to absolute maxima and minima values to determine whether a rough road condition exists.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific; embodiments disclosed herein may be combined in different ways to form additional embodiments, all of which fall within the scope of the present di ad osure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions. sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. it is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for detecting a rough road, comprising:
providing a vehicle sensor, the vehicle sensor configured to measure a steering torque of a vehicle;
receiving a steering torque data signal from the vehicle sensor;
generating a road condition data signal from the steering torque data signal;
evaluating the road condition data signal over a specified time interval;
comparing the road condition data signal with one or more thresholds; and
determining whether rough road conditions exist based on the comparison of the road condition data signal with the one or more thresholds over the specified time interval.

2. The method of claim 1, wherein comparing the road condition data signal with one or more thresholds comprises comparing the road condition data signal with a first threshold and a second threshold.

3. The method of claim 2, wherein the first threshold is a positive threshold and the second threshold is a negative threshold.

4. The method of claim 3, further comprising generating a rough road detection signal if the road condition data signal exceeds both of the first and second thresholds within the specified time interval.

5. The method of claim 1, wherein evaluating the road condition data signal further comprises determining a frequency of oscillations in the road condition data signal within the specified time interval.

6. The method of claim 5, wherein determining whether a rough road condition exists further comprises evaluating the frequency of oscillations in the road condition data signal within the specified time interval and comparing the frequency of oscillations with a threshold value.

7. The method of claim 1, further comprising calculating a rate of change of the steering torque data signal and comparing the rate of change of the steering torque data signal with a limit value.

8. The method of claim 7, further comprising comparing the rate of change of the steering torque data signal within the specified time interval, and, if the rate of change exceeds the limit value within the specified time interval, generating a rough road detection signal.

9. An automotive vehicle, comprising:
a suspension system configured to move in response to travel of the automotive vehicle over a road surface;
a steering system coupled to the suspension system;
a vehicle sensor configured to measure a steering torque;
a controller in communication with the vehicle sensor, the controller comprising a road detection system configured to
receive sensor data corresponding to the steering torque;
generate a road condition data signal;
compare the road condition data signal with one or more thresholds; and
generate a rough road detection signal based on the comparison of the road condition data signal to the one or more thresholds.

10. The automotive vehicle of claim 9, wherein comparing the road condition data signal with one or more thresholds comprises comparing the road condition data signal with a first threshold and a second threshold.

11. The automotive vehicle of claim 10, wherein the first threshold is a positive threshold and the second threshold is a negative threshold.

12. The automotive vehicle of claim 11, wherein the controller is further configured to generate a rough road detection signal if the road condition data signal exceeds both of the first and second thresholds within a specified time interval.

13. The automotive vehicle of claim 9, wherein the controller is further configured to calculate a rate of change of the road condition data signal and compare the rate of change of the road condition data signal with a limit value.

14. The automotive vehicle of claim 13, wherein the controller is further configured to compare the rate of change of the road condition data signal within a specified time interval, and, if the rate of change exceeds the limit value with the specified time interval, generate a rough road detection signal.

15. A system for detecting a road condition, comprising:
a vehicle sensor configured to measure a vehicle characteristic; and
a controller in communication with the vehicle sensor, the controller comprising a data synthesis module that synthesizes data from the vehicle sensor and generates a road condition signal indicative of the road condition, a comparison module that generates a data comparison signal based on a comparison of the road condition signal to one or more thresholds, and a detection module that analyzes the data comparison signal to determine whether a rough road condition is detected.

16. The system of claim 15, wherein the data synthesis module calculates a rate of change of the sensor data and the comparison module compares the rate of change to a limit value within a specified time interval.

17. The system of claim 15, wherein the comparison module compares the road condition signal to a first threshold and a second threshold, and the first threshold is a positive threshold and the second threshold is a negative threshold.

18. The system of claim 17, wherein the detection module generates a rough road detection signal if the road condition signal exceeds both of the first and second threshold within a specified time interval.
